(19) United States
(12) Patent Application Publication
(10) Pub. No.: US 2026/0310977 A1
(43) Pub. Date: Oct. 8, 2026

(54) AGENT CONTROL USING TOKEN-BASED DYNAMICS MODELS

(71) Applicant: GDM Holding LLC, Mountain View, CA (US)

(72) Inventors: Jingwei Zhang, London (GB); Emilio Parisotto, London (GB); Jost Tobias Springenberg, Guildford (GB); Leonard Hasenclever, London (GB); Nicolas Manfred Otto Heess, London (GB); Arunkumar Byravan, London (GB); Sarah Maria Elisabeth Bechtle, London (GB); Ingmar Fabian Fabian Schubert, Berlin (DE)

(21) Appl. No.: 19/481,609

(22) PCT Filed: May 3, 2024
(86) PCT No.: PCT/EP2024/062351

§ 371 Date: Nov. 5, 2025

Related U.S. Application Data
(60) Provisional application No. 63/500,558, filed on May 5, 2023.

(51) Int. Cl. G06N 3/09; G06N 3/045

(52) U.S. Cl. CPC G06N 3/09; G06N 3/045

(57) ABSTRACT

Methods, systems, and apparatus, including computer programs encoded on a computer storage medium, for controlling agents using sequence-processing neural networks. In particular, the sequence-processing neural network is used as a dynamics model of the environment in order to perform planning when selecting actions to be performed by an agent.

### CROSS-REFERENCE TO RELATED APPLICATION

This application claims priority to U.S. Provisional Application No. 63/500,558, filed on May 5, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that uses a token-based dynamics model to (i) control an agent interacting with an environment to perform a task in the environment or (ii) assist an agent interacting with an environment to perform a task in the environment.

For example, to control the agent at a given time step, the system performs planning using a sequence-processing neural network, e.g., an auto-regressive neural network, e.g., an auto-regressive self-attention neural network that includes causally-masked self-attention layers. In some implementations the auto-regressive neural network comprises a transformer neural network. In general, a transformer neural network may be a neural network that has a succession of self-attention neural network layers. A self-attention neural network layer has an attention layer input for each element of the input and is configured to apply an attention mechanism over the attention layer input to generate an attention layer output for each element of the input; there are many possible attention mechanisms that may be used. The transformer neural network may be referred to as a decoder-only Transformer neural network in the sense that it can be based on just the decoder of the original transformer architecture (Vaswani et al., 2017).

In particular, the system uses the sequence-processing, e.g., auto-regressive, neural network to model the dynamics of the environment in order to generate a plurality of planned trajectories starting from the current state of the environment.

Each planned trajectory includes data representing a respective observation at each of a sequence of planning time steps that starts at the current time step and includes a plurality of future time steps that are each after the current time step.

After generating the planned trajectories, the system selects a planned trajectory from the plurality of planned trajectories and causes the agent to perform the identified action for the first planning time step in the selected planned trajectory.

To generate a given planned trajectory, at each planning time step other than the last planning time step in the sequence, the system identifies an action to be performed by the agent in response to the observation at the planning time step in the planned trajectory. For example, the system can randomly select the action or can select the action using a control policy.

The system then generates data specifying the observation at the subsequent planning time step in the planned trajectory using the sequence-processing, e.g., auto-regressive neural network.

In particular, the system processes a first input sequence for the planning time step that includes (i) a sequence of tokens that are each selected from a vocabulary of tokens and that represent the respective observation in the planned trajectory at the planning time step and (ii) one or more tokens from the vocabulary of tokens that represent the identified action at the planning time step using the sequence-processing, e.g., auto-regressive neural network to generate an output sequence that includes a sequence of tokens from the vocabulary of tokens that represents the observation at the subsequent planning time step in the planned trajectory.

That is, the system uses an input sequence that “tokenizes” the observation at the planning time step and the identified action to generate as output a tokenized representation of the observation at the next time step. Thus, the system uses the sequence-processing, e.g., auto-regressive neural network as a dynamics model that predicts tokenized representations of observation given (at least) tokenized representations of the current observation and the identified action.

To provide more context, the input sequence can also include tokenized representations of the observations and identified actions at earlier planning time steps within the planning trajectory and, optionally, tokenized representations of the observations and performed actions at earlier time steps within the task episode.

Optionally, the input sequence can also include tokenized representations that have been received (for earlier time steps within the task episode), that have been predicted (for earlier planning time steps within the planning trajectory), or both.

The observation at a time step may be a multimodal observation, e.g., comprising one or more elements such as a still or moving image, text, e.g., in a natural language, sensor data, or any other data characterizing the environment.

An observation may be tokenized by converting the elements of the observation into respective tokens from a vocabulary that is made up of a discrete of tokens, with each token having a respective predetermined or learned embedding. For example, the system can discretize each numerical value within the observation so that that the numerical value corresponds to one of the tokens. As another example, when the observation includes multiple vectors, the system can discretize each vector to equal the closest embedding that corresponds to any token in the vocabulary.

The action may be discrete or continuous and may include multiple action dimensions. In these cases, the system can convert the action into token(s) by discretizing each of the action dimensions so that the value of each of the action dimensions corresponds to one of the tokens.

In implementations, because the auto-regressive neural network processes an observation at a planning time step to generate an output that represents an observation at a subsequent planning time step in the planned trajectory, it can be considered as building a model, in particular a dynamics model, of the agent in the environment. For example, in the case of a simulated or real-world physical agent the auto-regressive neural network can build a dynamics model of the physics of the agent, e.g., how parts of the agent move and interact, and of the environment. More generally, however, the auto-regressive neural network can build a dynamics model of the behavior of any agent in any type of environment.

The system can generate the plurality of planning trajectories in any of a variety of ways. As one example, the system can generate a fixed number of planning trajectories independently. As another example, the system can generate the planning trajectories by performing a search, e.g., a tree search, of the state-action space of the environment. For example, at each planning time step, the system can use quality scores for the partially generated planning trajectories as of the time step to determine which partially generated planning trajectories to further expand and which to prune, e.g., by only adding a new time step for the k highest scoring partial trajectories as of the time step. As yet another example, the system can use the sequence processing neural network to guide a monte carlo tree search (MCTS) of the state-action space of the environment.

As an example, the observation at a time step may comprise a natural language observation, and optionally also an image observation, relating to a simulated or real-world environment, and/or any other type of observation, e.g., one from a sensor sensing a state or configuration of the real-world, e.g., a state of one or more objects in the environment.

In some of these examples, the action to be performed in response to an observation may comprise a language action.

A language action may be an action that defines one or more language tokens to be emitted at a time step, e.g., a language action may be an action that outputs a natural language sentence. For example, a language policy output may define a distribution over a vocabulary of possible language tokens from which a language token is then selected. A language token may define a word or part of a word, or multiple words, e.g., a sentence or part of a sentence. Language tokens may include tokens representing punctuation. In some implementations the natural language output is generated by sampling one token at a time.

The dynamics model may comprise a learned model of how a human user interacts with an environment when performing a task. The observations may comprise language observations from the human user relating to the environment, e.g., describing the environment, describing the task, requesting clarifications, or generally participating in dialog. The observations may also comprise image observations, e.g., a captured image or a video clip.

As an example, the observations may be received from a digital assistant (also referred to as a virtual assistant) such as a smart speaker or display or from another computing device, e.g., a mobile device, and the language may be output from the device as audio or text.

The observation at a subsequent planning time step in the planned trajectory may comprise a language observation, an image observation, or any other type of observation. In general, the planned trajectory may relate to expected actions performed by the user. Thus, the language actions can be actions that guide the human user in performing the task, e.g., depending on the human's previous behavior, e.g., actions and verbalizations.

Thus, in these examples, the environment can be a real-world environment, the observations can be observations of the real-world environment, and the actions can comprise outputting user commands for performing a task in the real-world environment. In some implementations the commands may be executed automatically by a machine rather than by a human user. In some implementations the task may be a step or sub-task of a larger, overall task.

In some implementations one or more of the actions can include a success detection action, e.g., to tell the user, in natural language or otherwise, when a task, or a stage of a task, has successfully been completed.

In general a user interface for such a system may comprise, e.g., a mobile device, a keyboard (and optionally display), or a speech-based input mechanism, e.g., to input audio data characterizing a speech waveform of speech representing the input from the user in the natural or computer language and to convert the audio data into tokens representing the speech in the natural or computer language, i.e., representing a transcription of the spoken input. The user interface can also include a text or speech-based output, e.g., a display and/or a text-to-speech subsystem.

There is also described a method of controlling a robot based on the above-described method. The robot has a control system to obtain an observation and provide it to a policy system of the robot that specifies an action that is selected in response to the observation. The action can be selected by performing the operations of a method as described above.

In another implementation rather than using the auto-regressive neural network itself to generate the data specifying the observation at the subsequent planning time step in the planned trajectory, the auto-regressive neural network is distilled into a dynamics model neural network that is used to generate the data specifying the observation at the subsequent planning time step.

In another implementation instead of selecting an action by performing the operations of a method as described above, an action selection policy defined by a method as described above can be distilled into an action selection policy neural network that is used to select the action.

Particular embodiments of the subject matter described in this specification can be implemented so as to realize one or more of the following advantages.

This specification describes controlling an agent by using, as a dynamics model, a sequence-processing neural network that processes input sequences of tokens to generate output sequences of tokens. That is, the system uses the sequence-processing neural network predict representations of observations that would be received if a given action is performed by the agent in the environment.

In particular, by representing observations, actions, and rewards as tokens that can be processed and generated by the sequence-processing neural network, the system can leverage the large-scale representation capacity of large-scale sequence-processing neural networks, e.g., auto-regressive neural networks that are based on self-attention, e.g., a decoder-only Transformer neural network, in order to effectively and explicitly model the dynamics of an environment, resulting in improved agent control. For example, because the dynamics of the environment generalize better across tasks within an environment than do behavior policies, using the representation capacity of the sequence-processing neural network to model dynamics can allow the same sequence-processing neural network to be used to control (or assist) an agent to perform various different tasks within the environment, without needing to retrain the sequence-processing neural network.

As another example, dynamics may generalize better across different tasks in different environments than do behavior policies, allowing the same sequence-processing neural network to be used to control (or assist) an agent in multiple different environments without retraining. Thus, making use of the sequence-processing neural network as a dynamics model allows the system to effectively control an agent to perform a particular task in a particular environment, even when training data that demonstrates the particular task being performed is non-existent or limited and, moreover, even when training data representing interactions of an agent with the particular environment is non-existent or limited.

Moreover, because the sequence-processing neural network models dynamics rather than behavior policies, the sequence-processing neural network can be robust to changes in the training distribution and, more specifically, robust to training on suboptimal training data, i.e., on training data that reflects poor performance on any given task. Thus, the system can effectively control the agent even if the only training data that is available is of poor quality.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for controlling an agent at a given time step.

FIG. 3 is a flow diagram of an example process for generating an observation at a given planning time step in a given planned trajectory.

FIG. 4 is a flow diagram of an example process for generating each of the tokens in the data representing the observation at a given planning time step in a given planned trajectory.

FIG. 5 shows an example of tokenizing data to generate an input sequence for the sequence-processing neural network.

FIG. 6 shows an example of the performance of the described techniques.

Like reference numbers and designations in the various drawings indicate like elements.

### DETAILED DESCRIPTION

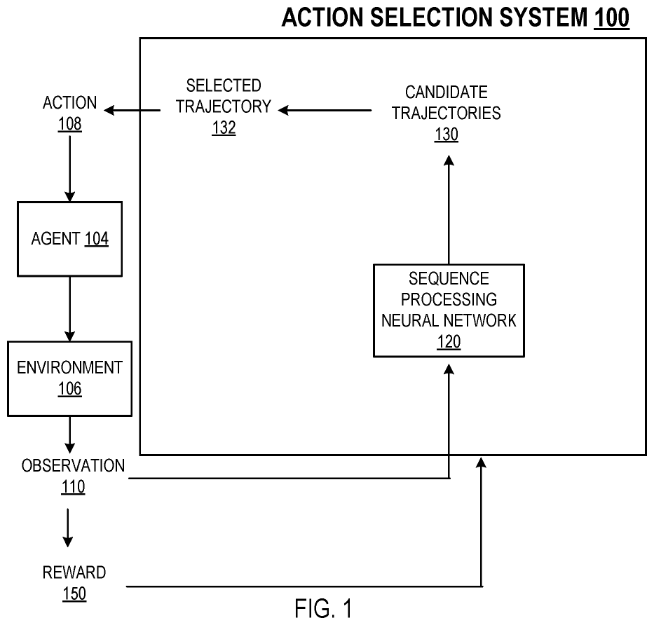

FIG. 1 shows an example action selection system 100. The action selection system 100 is an example of a system implemented as computer programs on one or more computers in one or more locations in which the systems, components, and techniques described below are implemented.

The action selection system 100 uses a sequence-processing neural network 120 to (i) control an agent 104 interacting with an environment 106 to perform a task in the environment 106 or (ii) assist an agent 104 interacting with an environment 106 to perform a task in the environment 106. For example, the agent 104 can be a robot, e.g., a robotic arm, a quadruped robot, a humanoid robot, or other type of robot that is controllable by the system 100.

Examples of agents, environments, and tasks will be described below.

When controlling the agent 104, the system 100 controls the agent 104 to accomplish a task by selecting actions 108 to be performed by the agent 104 at each of multiple time steps during the performance of an episode of the task.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent 104 performs the action 108, the environment 106 transitions into a new state.

The observation 110 can include any appropriate information that characterizes the state of the environment. As one example, the observation 110 can include sensor readings from one or more sensors configured to sense the environment. For example, the observation 110 can include one or more images captured by one or more cameras, measurements from one or more proprioceptive sensors, and so on.

In some cases, the system 100 receives an extrinsic reward 152 (also referred to as a “task” reward) from the environment in response to the agent performing the action.

Generally, the reward is a scalar numerical value and characterizes a progress of the agent towards completing the task.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during the episode of attempting to perform the task, i.e., so that non-zero rewards can be and frequently are received before the task is successfully completed.

In some cases, the reward can be generated by a reward model. As one example of this, the reward model may be learned using a success detector that detects successful behavior from observations of the environment, e.g., as described in “Vision-Language Models as Success Detectors” arXiv:2303.07280.

More specifically, to control the agent 104 at a given time step, the system 100 performs planning using the sequence-processing neural network 120.

Generally, the sequence-processing neural network 120 is configured to receive an input sequence of tokens and to process the input sequence of tokens to generate an output sequence of tokens.

For example, the sequence-processing neural network 120 can be an auto-regressive neural network that generates output sequences of tokens, e.g., an auto-regressive self-attention neural network that includes causally-masked self-attention layers.

In some implementations, the auto-regressive neural network 120 includes a transformer neural network. In general, a transformer neural network may be a neural network that has a succession of self-attention neural network layers. For example, the neural network 120 can have the architecture of a large language model (LLM) neural network.

A self-attention neural network layer has an attention layer input for each element of the input and is configured to apply an attention mechanism over the attention layer input to generate an attention layer output for each element of the input; there are many possible attention mechanisms that may be used. The transformer neural network may be referred to as a decoder-only Transformer neural network in the sense that it can be based on just the decoder of the original transformer architecture (Vaswani et al., 2017).

In more detail, the neural network 120 can be referred to as an auto-regressive neural network, i.e., because the neural network auto-regressively generates an output sequence of tokens. More specifically, the auto-regressively generated output is created by generating each particular token in the output sequence conditioned on a current input sequence that includes at least some of the tokens that precede the particular token in the output sequence, i.e., the tokens that have already been generated for any previous positions in the output sequence that precede the particular position of the particular token.

For example, the neural network 120 can be an auto-regressive attention neural network that includes (i) a plurality of attention blocks that each apply a self-attention operation and (ii) an output subnetwork that processes an output of the last attention block to generate a score distribution over tokens in the vocabulary, e.g., a score distribution used for selecting an output token, e.g., by sampling from the score distribution or selecting a most likely token according to the score distribution. The self-attention operation applied by some or all of the attention blocks can be causally-masked, so that, for each position in the sequence, only the tokens at the position and at positions preceding the position are assigned non-zero attention weights.

In this example, the neural network 120 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

More specifically, the neural network 120 includes a plurality of layers that include a plurality of attention layers.

Each attention layer receives a respective hidden state for each of the input positions in the input sequence and updates the respective hidden states for each of the input positions by applying an attention mechanism to the respective hidden states. That is, each hidden state corresponds to a respective input token within the input sequence, i.e., the hidden state for a given input position corresponds to the token at the given input position.

For the first attention layer in the neural network 120, the respective hidden states can be the input tokens in the input sequence or the input tokens after having been modified by one or more initial layers of the neural network. For the subsequent attention layers in the sequence, the respective hidden states can be the outputs of a preceding layer within the attention neural network.

As a particular example, the system can use a neural network having the architecture described in Reed, et al, “A Generalist Agent”, arXiv:2205.06175, the entire contents of which are hereby incorporated by reference herein in their entirety.

In particular, the system 100 uses the sequence-processing neural network 120 to model the dynamics of the environment in order to generate a plurality of planned trajectories 130 starting from the current state of the environment as of the time step.

Each planned trajectory 130 includes data representing a respective observation at each of a sequence of planning time steps that starts at the current time step and includes a plurality of future time steps that are each after the current time step.

When controlling the agent 104, after generating the planned trajectories 130, the system 100 selects a planned trajectory 132 from the plurality of planned trajectories 130 and causes the agent to perform the identified action 108 for the first planning time step in the selected planned trajectory 132.

To generate a given planned trajectory 130, at each planning time step other than the last planning time step in the trajectory, the system 100 identifies an action to be performed by the agent in response to the observation at the planning time step in the planned trajectory.

For example, to identify the action, the system 100 can randomly select the action or can select the action using a control policy. This is described in more detail below.

The system 100 then generates data specifying the observation at the subsequent planning time step in the planned trajectory using the sequence-processing neural network 120.

In particular, the system 100 processes a first input sequence for the planning time step that includes (i) a sequence of tokens that are each selected from a vocabulary of tokens and that represent the respective observation in the planned trajectory at the planning time step and (ii) one or more tokens from the vocabulary of tokens that represent the identified action at the planning time step using the sequence-processing to generate an output sequence that includes a sequence of tokens from the vocabulary of tokens that represents the observation at the subsequent planning time step in the planned trajectory.

That is, the system 100 uses an input sequence that “tokenizes” the observation at the planning time step and the identified action to generate as output a tokenized representation of the observation at the next time step. Tokenizing a given data item, e.g., an observation, action, or reward, generally refers to representing the data item as one or more tokens from the vocabulary of tokens.

Thus, the system 100 uses the sequence-processing neural network 120 as a dynamics model that predicts tokenized representations of observations given (at least) tokenized representations of the current observation and the identified action.

To provide more context, the input sequence can also include tokenized representations of the observations and identified actions at earlier planning time steps within the planned trajectory and, optionally, tokenized representations of the observations and performed actions at earlier time steps within the task episode. Optionally, the input sequence can also include tokenized representations of the rewards at earlier planning time steps, earlier time steps within the task episode, or both. For example, an earlier history of observations, rewards, and actions, of arbitrary length may be included in the input sequence. For example, the system may predict the outcome of action sequences, given the current observation as start, and the history of the agent's interaction with the environment since the beginning of the episode.

In other words, optionally, the input sequence can also include tokenized representations that have been received (for earlier time steps within the task episode), that have been predicted (for earlier planning time steps within the planned trajectory), or both.

The observation 100 at a time step may be a multimodal observation, e.g., including one or more elements such as a still or moving image, text, e.g., in a natural language, sensor data, or any other data characterizing the environment.

An observation 110 may be tokenized by converting the elements of the observation into respective tokens from a vocabulary that is made up of a discrete set of tokens, with each token having a respective predetermined or learned embedding. An embedding is an ordered collection of numerical values having a pre-determined dimensionality, e.g., a vector of floating point or other numeric values having a pre-determined number of entries.

For example, the system 100 can discretize each numerical value within the observation so that that the numerical value corresponds to one of the tokens.

As another example, when the observation includes multiple vectors, the system can discretize each vector to equal the closest embedding that corresponds to any token in the vocabulary.

As yet another example, the system 100 can process the observation using an encoder neural network to generate a representation that includes multiple vectors, and then discretize each vector to equal the closest embedding that correspond to any token in the vocabulary.

The action may be discrete or continuous and may include multiple action dimensions. In these cases, the system can convert the action into token(s) by discretizing each of the action dimensions so that the value of each of the action dimensions corresponds to one of the tokens.

In some implementations, because the sequence-processing neural network 120 processes an observation at a planning time step to generate an output that represents an observation at a subsequent planning time step in the planned trajectory, it can be considered as building a model, in particular a dynamics model, of the agent in the environment. For example, in the case of a simulated or real-world physical agent the sequence-processing neural network 120 can build a dynamics model of the physics of the agent, e.g., how parts of the agent move and interact, and of the environment. More generally, however, the sequence-processing neural network 120 can build a dynamics model of the behavior of any agent in any type of environment.

The system 100 can generate the plurality of planned trajectories 130 in any of a variety of ways.

As one example, the system 100 can generate a fixed number of planned trajectories independently.

As another example, the system 100 can generate the planned trajectories by performing a search, e.g., a tree search, of the state-action space of the environment.

For example, at each planning time step, the system 100 can use quality scores for the partially generated planned trajectories as of the time step to determine which partially generated planned trajectories to further expand and which to prune, e.g., by only adding a new time step for the k highest scoring partial trajectories as of the time step.

Generating a quality sore for a partially generated trajectory is described in more detail below.

As yet another example, the system 100 can use the sequence processing neural network 120 to guide a monte carlo tree search (MCTS) of the state-action space of the environment.

Some example techniques for generating planned trajectories 130 are described in more detail below.

Prior to using the sequence processing neural network 120 to control the agent 104, the system 100 or another training system trains the sequence processing neural network 120.

In particular, the trains the neural network 120 has been trained on a plurality of training sequences of tokens from the vocabulary to optimize a task objective.

For example, the task objective can include a next token prediction objective. The next token prediction objective is an objective that requires predicting the next token in a given sequence given the existing tokens in the given sequence. For example, the next token prediction objective can be expressed as:

$$L = - {\sum }_{i = 1}^{q} log ( {p}_{θ} ( {t}_{i} \vert {t}_{1} … {t}_{i - 1} ) ,$$

where q is the total number of tokens in the input sequence, tᵢ is the token at position i in the input sequence, and θ represents the neural network 120.

The training system can train the neural network 120 using any of a variety of paradigms that define what is represented by the training sequences of tokens.

For example, one or more of the training sequences of tokens can be transition sequences representing interactions with the environment, e.g., of the agent when controlled by a different policy or of an expert agent. A “transition” sequence is a sequence of tokenized observations, actions, and rewards across a sequence of interactions of a given agent with the environment.

In some cases, one or more of the training sequences of tokens can be transition sequences representing interactions of a second agent with a second environment, where the second agent is different from the agent, the second environment is different from the environment, or both.

In some implementations, the training system may have access to only a limited number of training sequences for the environment 110. In some of these implementations, the training system can make use of few-shot learning to leverage other interactions with other environments to make up for the limited availability of training data. As a particular example, the training system can pre-train the sequence-processing neural network 120 on training sequences representing interactions of one or more agents with one or more different environments and then fine-tune on the transition sequences representing interactions of the agent with the environment.

In some implementations, the training system may not have access to any training sequences for the environment 110. In some of these implementations, the training system can make use of zero-shot learning to leverage other interactions with other environments to make up for the lack of availability of training data. As a particular example, the training system can pre-train the sequence-processing neural network 120 on training sequences representing interactions of one or more agents with one or more different environments and then use the sequence-processing neural network 120 control the agent as described above without any additional fine-tuning.

In some implementations, when the agent 104 is a mechanical agent interacting with a real-world environment, the training system can train the neural network 120 using a simulation of the mechanical agent in a simulation of the real-world environment for use in controlling the mechanical agent in the real-world environment.

Additionally, in some implementations, rather than directly using the sequence-processing neural network 120, the system 100 or the other training system can make use of distillation training to “distill” the control policy described above into a more computationally-efficient neural network.

For example, the training system can distill the neural network 120 into a dynamics model neural network, e.g., one that is more computationally-efficient than the neural network 120. As another example, the action selection policy described above, i.e., that selects actions by planning using the neural network 120, can be distilled into an action selection policy neural network that is used to select actions to control the agent, e.g., without performing any planning.

When the agent 104 is a robot or other mechanical agent, the system 100 can be implemented local to the agent 104 or remote from the agent 104.

When the system is local to the mechanical agent, the system 100 can directly control the agent to perform the action 108.

When the system 100 is remote from the agent 104, the control system of the agent, e.g., the robot, can obtain the observation 110 and then provide the observation 110 to the system 100, e.g., over a data communication network. The system 100 can then select the action 108 as described above and transmit data identifying the action 108 to the control system of the agent, which can control the agent using the identified action 108.

As an example, the observation 110 at a time step may comprise a natural language observation, and optionally also an image observation, relating to a simulated or real-world environment, and/or any other type of observation, e.g., one from a sensor sensing a state or configuration of the real-world, e.g., a state of one or more objects in the environment.

In some of these examples, the action to be performed in response to an observation may comprise a language action.

A language action may be an action that defines one or more language tokens to be emitted at a time step, e.g., a language action may be an action that outputs a natural language sentence. For example, a language policy output may define a distribution over a vocabulary of possible language tokens from which a language token is then selected. A language token may define a word or part of a word, or multiple words, e.g., a sentence or part of a sentence. Language tokens may include tokens representing punctuation. In some implementations the natural language output is generated by sampling one token at a time.

Thus, in these cases, the dynamics model may comprise a learned model of how a human user interacts with an environment when performing a task. The observations may comprise language observations from the human user relating to the environment, e.g., describing the environment, describing the task, requesting clarifications, or generally participating in dialog. The observations may also comprise image observations, e.g., a captured image or a video clip.

As an example, the observations may be received from a digital assistant (also referred to as a virtual assistant) such as a smart speaker or display or from another computing device, e.g., a mobile device, and the language may be output from the device as audio or text.

The observation at a subsequent planning time step in the planned trajectory may comprise a language observation, an image observation, or any other type of observation. In general, the planned trajectory may relate to expected actions performed by the user. Thus, the language actions can be actions that guide the human user in performing the task, e.g., depending on the human's previous behavior, e.g., actions and verbalizations.

Thus, in these examples, the environment can be a real-world environment, the observations can be observations of the real-world environment, and the actions can comprise outputting user commands for performing a task in the real-world environment. In some implementations the commands may be executed automatically by a machine rather than by a human user. In some implementations the task may be a step or sub-task of a larger, overall task.

In some implementations one or more of the actions can include a success detection action, e.g., to tell the user, in natural language or otherwise, when a task, or a stage of a task, has successfully been completed.

In general a user interface for such a system may comprise, e.g., a mobile device, a keyboard (and optionally display), or a speech-based input mechanism, e.g., to input audio data characterizing a speech waveform of speech representing the input from the user in the natural or computer language and to convert the audio data into tokens representing the speech in the natural or computer language, i.e., representing a transcription of the spoken input. The user interface can also include a text or speech-based output, e.g., a display and/or a text-to-speech subsystem.

In another implementation rather than using the auto-regressive neural network itself to generate the data specifying the observation at the subsequent planning time step in the planned trajectory, the auto-regressive neural network is distilled into a dynamics model neural network that is used to generate the data specifying the observation at the subsequent planning time step.

In another implementation instead of selecting an action by performing the operations of a method as described above, an action selection policy defined by a method as described above can be distilled into an action selection policy neural network that is used to select the action.

Examples of environments, actions, and agents that the system can control will be described in more detail below.

When the system 100 is assisting the agent 104, the system 100 provides, to the agent 108, information about how to perform the task that is generated using at least the selected action 108. For example, the system 100 can use a generative neural network to map the selected action to a natural language output, a speech output, an image output, or a video output, and provide the output for presentation to the agent 104.

For example, the agent that is assisted can be a human. For example, assisting the agent, i.e., the human, can include communicating with a human user of a digital assistant (also referred to as a virtual assistant) such as a smart speaker or display, mobile, or other device, that implements the method.

In more detail, in some implementations the agent comprises a human user of a digital assistant such as a smart speaker, smart display, or other device. Then, information defining the task can be obtained from the digital assistant, and the digital assistant can be used to provide information to the user based on the latent vector. For example, this may comprise receiving, at the digital assistant, a request from the user for assistance and determining, in response to the request, one or more tasks for the user to perform, e.g., steps or sub-tasks of an overall task. Then for one or more tasks of the series of tasks, e.g., for each task, e.g., until a final task of the series the digital assistant can be used to output to the user information indicating how to perform the task. This may be done using natural language, e.g., on a display and/or using a speech synthesis subsystem of the digital assistant. Visual, e.g., video, and/or audio observations of the user performing the task may be captured, e.g., using the digital assistant.

As an illustrative example a user may be interacting with a digital assistant and ask for help performing an overall task consisting of multiple steps, e.g., cooking a pasta dish. While the user performs the task, the digital assistant receives audio and/or video inputs representative of the user's progress on the task, e.g., images or video or sound clips of the user cooking. The digital assistant uses a system as described above, in particular by providing it with the captured audio and/or video to determine how the user should complete each step.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g., a conversation agent such as LaMDA. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks, e.g., of a series of tasks, e.g., until a final task of the series. More particularly the assistance control subsystem can capture, using the observation capture subsystem, visual or audio observations of the user performing the task, determine how to perform the task, and provide information about how to perform the task.

Some examples of the types of agents the system can control now follow.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example, in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example, in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example, the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example, the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general, the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example, in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example, a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general, the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example, a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example, in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example, in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example, a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example, rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus, a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally, in the case of a simulated environment the observations may include simulated versions of one or more of the previously described observations or types of observations and the actions may include simulated versions of one or more of the previously described actions or types of actions. For example, the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally, the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example, the system may be partly trained using a simulation of a mechanical agent in a simulation of a particular real-world environment, and afterwards deployed to control the real mechanical agent in the particular real-world environment. Thus, in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

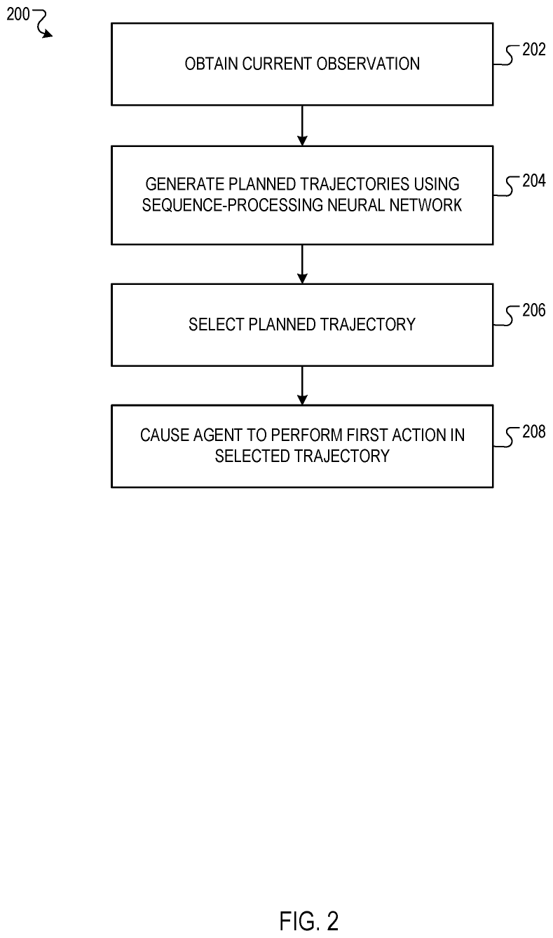

FIG. 2 is a flow diagram of an example process 200 for controlling the agent at a given time step during a task episode. For convenience, the process 200 will be described as being performed by a system of one or more computers located in one or more locations. For example, an action selection system, e.g., the action selection system 100 of FIG. 1, appropriately programmed in accordance with this specification, can perform the process 200.

For example, the system can perform the process 200 at each time step in the episode or at a proper subset of the time steps in the episode. That is, the system can perform planning at each time step in the episode or at only a proper subset of time steps in the episode.

The system obtains a current observation characterizing a current state of the environment at the time step (step 202).

The system then generates a plurality of planned trajectories starting from the current state of the environment (step 204).

Generally, each planned trajectory includes data representing a respective observation at each of a sequence of planning time steps that starts at the current time step and includes a plurality of future time steps that are each after the current time step. For example, the number of future time steps in each planned trajectory can be a pre-determined, fixed number or can be a variable number.

At a high-level, the system generates each trajectory using the sequence-processing neural network described above. In particular, the system uses the sequence-processing neural network to generate the data representing the observation at each time step in each of the trajectories.

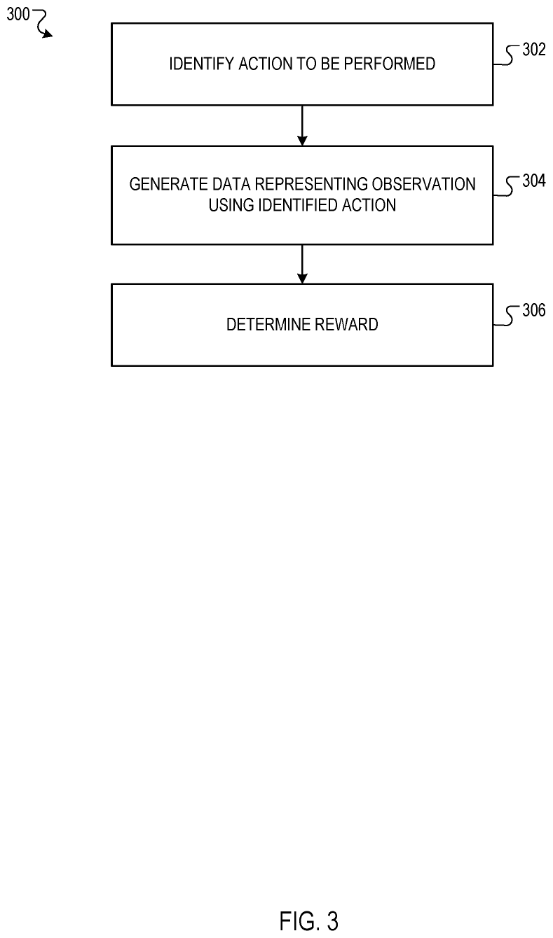

This will be described in more detail below with reference to FIG. 3.

The system selects a planned trajectory from the plurality of planned trajectories (step 206).

Generally, the system determines a respective quality score for each planned trajectory and then selects the planned trajectory having the highest quality score.

In some examples, the system determines the quality scores based on rewards for the planning time steps in the planned trajectories.

That is, in these examples, the system determines a respective reward for each planning time step in the planned trajectory (other than the first time step in the planned trajectory), and then determines the quality score for the trajectory from the rewards for the planning time steps in the planned trajectory. For example, the quality score can be the sum, average, or time-discounted sum of the rewards for the planning time steps in the planned trajectory.

Determining rewards for time steps in a planned trajectory will be described in more detail below with reference to FIG. 3.

The system causes the agent to perform the identified action for the first planning time step in the selected planned trajectory (step 208).

In other words, given an objective function ƒ that outputs the quality score and a set of candidate planned future trajectories {A(1), . . . , A(K)}, the system compares these in terms of the objective function ƒ i.e., in terms of the quality scores, and selects the first action of the planned trajectory that maximizes ƒ.

As will be described in more detail below, while the objective function ƒ explicitly depends on the rewards for the time steps in the planned trajectory, the rewards may not be a deterministic function of the observations and actions. In these cases, the sequence-processing neural network may be used to predict a future distribution of both observations and rewards or a separate learned model may be used to predict the future distribution of rewards.

When the system does not control the agent, the system can provide, to the agent, information about how to perform the task that is generated using at least the identified action for the first planning time step in the selected planned trajectory.

FIG. 3 is a flow diagram of an example process 300 for generating an observation at a given planning time step in a given planned trajectory. For convenience, the process 300 will be described as being performed by a system of one or more computers located in one or more locations. For example, an action selection system, e.g., the action selection system 100 of FIG. 1, appropriately programmed in accordance with this specification, can perform the process 300.

In particular, the system can perform the process 300 at each planning time step in the given planned trajectory other than the last planning time step in the trajectory to generate the data representing the observation at the subsequent planning time step in the trajectory, i.e., at the next planning time step that immediately follows the planning time step within the trajectory.

The system identifies an action to be performed by the agent in response to the observation at the given planning time step in the given planned trajectory (step 302).

The system can identify the action to be performed by the agent in any of a variety of ways.

As one example, the system can randomly select the action to be performed at the planning time step in the planned trajectory from a set of actions that can be represented by one or more tokens from the vocabulary.

As one example of this, a set of candidate action sequences can be randomly sampled independent of the current observation at the time step. For example, each planned trajectory may correspond to a candidate action sequence in the set of candidate action sequences, and for the given planned trajectory, the next action in the corresponding candidate action sequence, i.e., the action that immediately follows the action that was identified at the preceding planning time step in the given planned trajectory, is identified.

As another example of this, rather than randomly sample an entire candidate action sequence, the system randomly samples an action from the set each time an action is required to be identified.

As another example, the system can apply a control policy for the agent to at least the observation at the planning time step in the planned trajectory to select the action to be performed by the agent.

For example, the control policy can be a learned policy that maps an observation to an action to be performed by the agent. In this example, to ensure that the planned trajectories cover distinct portions of the space of possible planned trajectories, the system can optionally add noise to the output of the control policy and then identify the resulting noisy action as the identified action.

As one example of a learned policy, the system can use the sequence-processing neural network to implement the control policy.

In this example, the system can process a third input sequence for the planning time step using the auto-regressive neural network to generate one or more tokens representing the action to be performed by the agent at the planning time step. The third input sequence generally includes the sequence of tokens representing the observation at the planning time step in the planned trajectory. Optionally, the third input sequence can also include a historical sequence, a described above. In these cases, the third input sequence can include one or more separator tokens from the vocabulary that separate tokens corresponding to different planning time steps.

The system then generates data specifying the observation at the subsequent planning time step using the identified action (step 304).

In particular, as part of generating the data, the system processes a first input sequence for the planning time step that includes (i) a sequence of tokens from the vocabulary of tokens and representing the respective observation in the planned trajectory at the given planning time step and (ii) one or more tokens from the vocabulary of tokens and representing the identified action at the planning time step, using the sequence-processing neural network, to generate an output sequence that includes a sequence of tokens from the vocabulary of tokens that represents the observation at the subsequent planning time step in the planned trajectory.

Generally, because observations can include higher-dimensional data, each observation can be represented as a sequence of multiple tokens. That is, each observation can be represented as a sub-sequence that includes a respective token at each of multiple time steps.

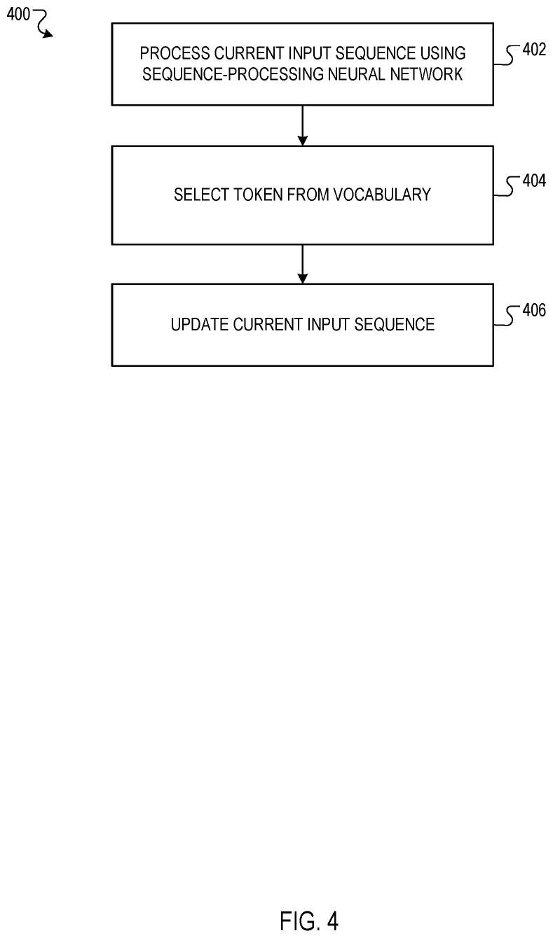

Generating the tokens at each of the time steps in the sub-sequence is described in more detail below with reference to FIG. 4.

In some cases, the first input sequence can also include, for each planning time step preceding the planning time step in the planned trajectory, the sequence of tokens representing the observation at the preceding planning time step and the identified action for the preceding planning time step.

In other words, for each planning time step, the first input sequence can include a historical sequence that comprises, for each of one or more time steps preceding the current time step in the task episode, a sequence of tokens from the vocabulary representing the observation at the time step and one or more tokens from the vocabulary representing an action performed by the agent at the time step. In some of these cases, the first input sequence further includes one or more separator tokens from the vocabulary that separate tokens corresponding to different planning time steps.

As described above, in some examples, the system also determines a respective reward for the subsequent planning time step (step 306).

The system can generate the respective reward for a planning time step in any of a variety of ways.

As one example, the system can determine the respective reward for the planning time step from the sequence of tokens representing the observation at the planning time step. For example, the system can apply a pre-determined or learned function to extract a reward for the planning step from the sequence of tokens representing the observation. That is, the system can generate the reward using a fixed mapping from tokenized observations to reward values or using a learned reward model.

For example, the system can use the sequence-processing neural network to generate the reward. In this example, the system can process a second input sequence for the planning time step that includes the sequence of tokens representing the observation at the planning time step in the planned trajectory, using the sequence-processing neural network, to generate a token from the vocabulary that represents the respective reward for the planning time step. Optionally, the second input sequence can also include a historical sequence as described above.

FIG. 4 is a flow diagram of an example process 400 for generating each of the tokens in the data representing the observation at a given planning time step in a given planned trajectory. For convenience, the process 400 will be described as being performed by a system of one or more computers located in one or more locations. For example, an action selection system, e.g., the action selection system 100 of FIG. 1, appropriately programmed in accordance with this specification, can perform the process 400.

The system processes a current input sequence using the sequence-processing neural network to generate a score distribution over the vocabulary of tokens (step 402).

For the first position in the sub-sequence, the current input sequence includes the first input sequence.

For each subsequent position, the current input sequence includes the first input sequence followed by the tokens at each preceding position in the output sequence.

The system selects a token from the vocabulary of tokens in accordance with the score distribution (step 404). For example, the system can select the token with the highest score in the score distribution. As another example, the system can sample a token from the vocabulary using the score distribution, e.g., so that each token is sampled with a likelihood that is determined by the score for the token in the score distribution.

The system updates the current input sequence by appending the selected token to the current input sequence (step 406), i.e., by adding the selected token to the end of the current input sequence.

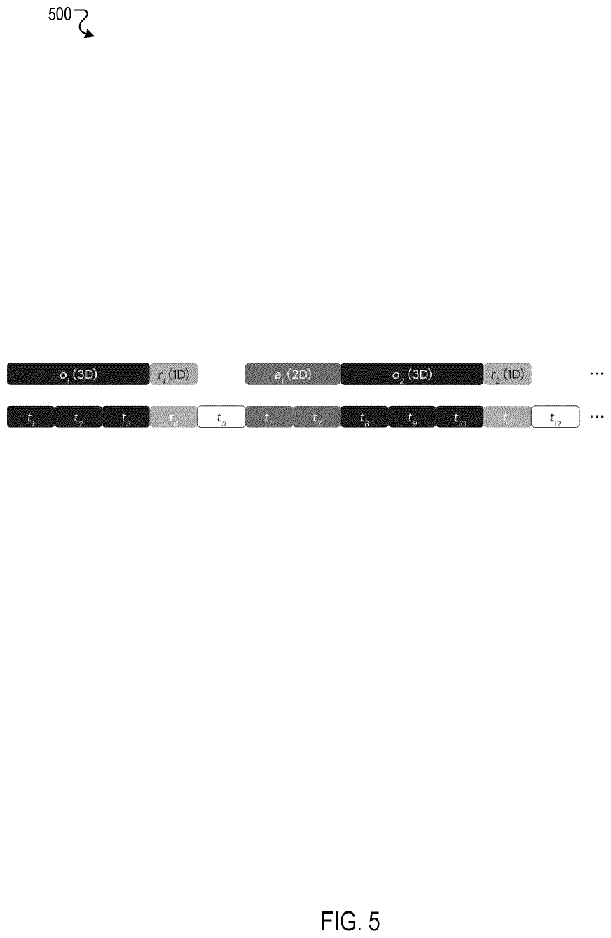

FIG. 5 shows an example 500 of tokenizing data to generate an input sequence for the sequence-processing neural network.

As described above, in order to allow observations, actions, and rewards to be processed by the sequence-processing neural network, the system tokenizes each of these data items into a respective set of tokens from the vocabulary. Different types of data items can be tokenized into different numbers of tokens. For example, observations can be tokenized into a larger number of tokens than actions or rewards.

As can be seen from the example 500, the system tokenizes each observation into three tokens from the vocabulary, each action into two tokens from the vocabulary, and each reward into a single token from the vocabulary. In an example, an n-dimensional observation is represented by a sequence of n integers (t1, . . . , tn), an m-dimensional action is represented by a sequence of m integers (t1, . . . , tm), and a reward is represented by a single integer. This is an example of a per-dimension tokenization scheme. In some examples, different environments may have observation and action spaces of different dimensionalities. All of these may be translated into sequences of tokens (although of different per-timestep length depending on the dimensionality), which provide a unified interface. In other examples, a single token may be used per state or action, obtained with a learned projection.

The system also inserts constant separator tokens, e.g., tokens t5 and t12, into the sequence to separate data from different time steps, i.e., to mark the start of a new time step.

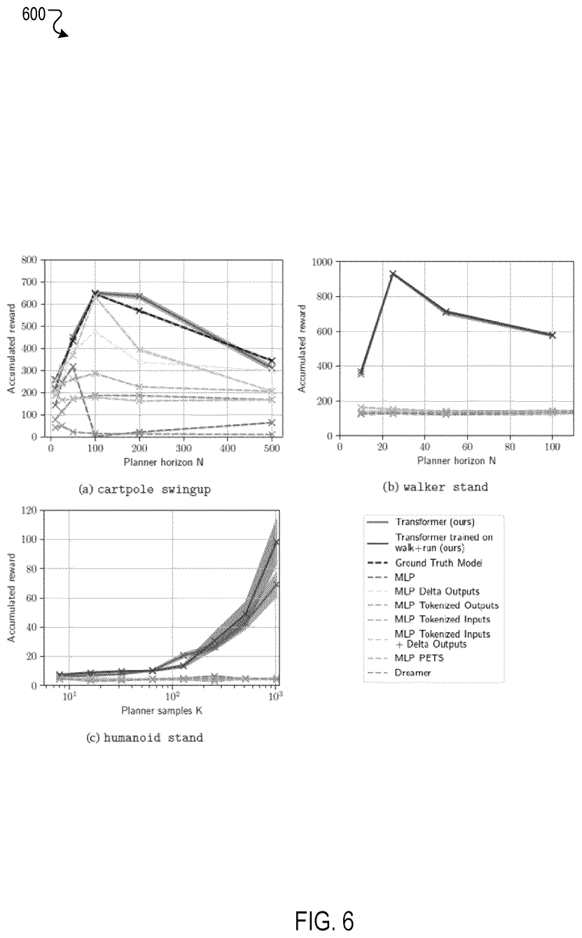

FIG. 6 shows an example 600 of the performance of the described techniques relative to a variety of baseline techniques and to existing approaches on three different tasks. In particular, the example 600 shows the performance of each technique in terms of total accumulated rewards, such that accumulating higher rewards reflects improved performance on the corresponding task.

In particular, example 1 (labeled as TDM (ours) in the Figure) refers to an example of the described techniques that use a decoder-only transformer neural network as the sequence processing neural network and that has been trained on a data set of a humanoid robot walking in an environment. Example 2 (labeled as TDM trained on walk+run (ours) in the Figure) refers to an example of the described techniques that use a decoder-only transformer neural network as the sequence processing neural network and that has been trained on a data set of a humanoid robot walking in an environment and another data set of a humanoid robot running in an environment.

As can be seen from the example 600, the examples of the described techniques (labeled as “ours”) outperform the baseline techniques for a variety of planner horizons (the number of planner time steps in each planned trajectories) and for a variety of planner samples (the number of planned trajectories generated at each time step).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

1. A method performed by one or more computers and for controlling an agent interacting with an environment to perform a task episode, the method comprising:
at each of a plurality of current time steps in the task episode:
obtaining an observation characterizing a current state of the environment at the time step;
generating a plurality of planned trajectories starting from the current state of the environment, wherein each planned trajectory comprises data representing a respective observation at each of a sequence of planning time steps that starts at the current time step and includes a plurality of future time steps that are each after the current time step, the generating comprising, for each planned trajectory and at each planning time step other than a last planning time step in the sequence:
identifying an action to be performed by the agent in response to the observation at the planning time step in the planned trajectory; and
generating data specifying the observation at the subsequent planning time step in the planned trajectory, comprising processing a first input sequence for the planning time step that comprises a sequence of tokens from a vocabulary of tokens and representing the respective observation in the planned trajectory at the planning time step and one or more tokens from the vocabulary of tokens and representing the identified action at the planning time step, using a sequence-processing neural network, to generate an output sequence that comprises a sequence of tokens from the vocabulary of tokens that represents the observation at the subsequent planning time step in the planned trajectory;
selecting a planned trajectory from the plurality of planned trajectories; and
causing the agent to perform the identified action for the first planning time step in the selected planned trajectory.

2. The method of claim 1, wherein the sequence-processing neural network is an auto-regressive neural network.

3. The method of claim 1, wherein selecting a planned trajectory from the plurality of planned trajectories comprises:
determining a respective quality score for each planned trajectory; and
selecting the planned trajectory having a highest quality score.

4. The method of claim 3, wherein determining a respective quality score for each planned trajectory comprises:
determining a respective reward for each planning time step after the first planning time step in the planned trajectory; and
determining the respective quality score for the planned trajectory from the respective rewards.

5. The method of claim 4, wherein determining a respective reward for each planning time step after the first planning time step in the planned trajectory comprises:
determining the respective reward for the planning time step from the sequence of tokens representing the observation at the planning time step in the planned trajectory.

6. The method of claim 4, wherein determining a respective reward for each planning time step after the first planning time step in the planned trajectory comprises:
processing a second input sequence for the planning time step comprising the sequence of tokens representing the observation at the planning time step in the planned trajectory, using the sequence-processing neural network, to generate a token from the vocabulary that represents the respective reward for the planning time step.

7. The method of claim 6, wherein the second sequence comprises, for each planning time step preceding the planning time step in the planned trajectory, the sequence of tokens representing the observation at the preceding planning time step and the identified action for the preceding planning time step.

8. The method of claim 7, wherein the second sequence further comprises, for each planning time step preceding the planning time step in the planned trajectory, the token that represents the respective reward for the planning time step.

9. The method of claim 1, wherein, for each planning time step, the first input sequence further comprises, for each planning time step preceding the planning time step in the planned trajectory, the sequence of tokens representing the observation at the preceding planning time step and the identified action for the preceding planning time step.

10. The method of claim 9, wherein, for each planning time step, the first input sequence comprises a historical sequence that comprises, for each of one or more time steps preceding the current time step in the task episode, a sequence of tokens from the vocabulary representing the observation at the time step and one or more tokens from the vocabulary representing an action performed by the agent at the time step.

11. The method of claim 1, wherein identifying an action to be performed by the agent in response to the observation at the planning time step in the planned trajectory comprises:
randomly selecting the action to be performed at the planning time step in the planned trajectory from a set of actions that can be represented by one or more tokens from the vocabulary.

12. The method of claim 1, wherein identifying an action to be performed by the agent in response to the observation at the planning time step in the planned trajectory comprises:
applying a control policy for the agent to at least the observation at the planning time step in the planned trajectory to select the action to be performed by the agent.

13. The method of claim 12, wherein applying a control policy for the agent to at least the observation at the planning time step in the planned trajectory to select the action to be performed by the agent comprises:
processing a third input sequence for the planning time step comprising the sequence of tokens representing the observation at the planning time step in the planned trajectory using the sequence-processing neural network to generate one or more tokens representing the action to be performed by the agent at the planning time step.

14. The method of claim 1, wherein the sequence-processing neural network has been trained on a plurality of training sequences of tokens from the vocabulary to optimize a task objective that comprises a next token prediction objective.

15. The method of claim 14, wherein one or more of the training sequences of tokens are transition sequences representing interactions with the environment.

16. The method of claim 14, wherein one or more of the training sequences of tokens are transition sequences representing interactions of a second agent with a second environment, wherein the second agent is different from the agent, the second environment is different from the environment, or both.

17. The method of claim 15, wherein the auto-regressive neural network has been pre-trained on training sequences representing interactions of one or more agents with one or more different environments and fine-tuned on the transition sequences representing interactions of the agent with the environment.

18. The method of claim 9, wherein the first input sequence further comprises one or more separator tokens from the vocabulary that separate tokens corresponding to different planning time steps.

19. The method of claim 1, wherein processing the first input sequence for the planning time step using the sequence-processing neural network to generate the output sequence that comprises a sequence of tokens from the vocabulary of tokens that represents the observation at the subsequent planning time step in the planned trajectory comprises, for each position starting from a first position in the output sequence:
processing a current input sequence using the sequence-processing neural network to generate a score distribution over the vocabulary of tokens, wherein for the first position the current input sequence comprises the first input sequence and wherein for each subsequent position the current input sequence comprises the first input sequence followed by the tokens at each preceding position in the output sequence;
selecting a token from the vocabulary of tokens in accordance with the score distribution; and
updating the current input sequence by appending the selected token to the current input sequence.

20. The method of claim 1, wherein the sequence-processing neural network is a self-attention neural network that comprises one or more causally masked self-attention layers.

21-29. (canceled)

30. A system comprising one or more computers and one or more storage devices storing instructions that when executed by the one or more computers cause the one more computers to perform operations for controlling an agent interacting with an environment to perform a task episode, the operations comprising:
at each of a plurality of current time steps in the task episode:
obtaining an observation characterizing a current state of the environment at the time step;
generating a plurality of planned trajectories starting from the current state of the environment, wherein each planned trajectory comprises data representing a respective observation at each of a sequence of planning time steps that starts at the current time step and includes a plurality of future time steps that are each after the current time step, the generating comprising, for each planned trajectory and at each planning time step other than a last planning time step in the sequence:
identifying an action to be performed by the agent in response to the observation at the planning time step in the planned trajectory; and
generating data specifying the observation at the subsequent planning time step in the planned trajectory, comprising processing a first input sequence for the planning time step that comprises a sequence of tokens from a vocabulary of tokens and representing the respective observation in the planned trajectory at the planning time step and one or more tokens from the vocabulary of tokens and representing the identified action at the planning time step, using a sequence-processing neural network, to generate an output sequence that comprises a sequence of tokens from the vocabulary of tokens that represents the observation at the subsequent planning time step in the planned trajectory;
selecting a planned trajectory from the plurality of planned trajectories; and
causing the agent to perform the identified action for the first planning time step in the selected planned trajectory.

31. One or more non-transitory computer storage media storing instructions that when executed by one or more computers cause the one more computers to perform operations for controlling an agent interacting with an environment to perform a task episode, the operations comprising:
at each of a plurality of current time steps in the task episode:
obtaining an observation characterizing a current state of the environment at the time step;
generating a plurality of planned trajectories starting from the current state of the environment, wherein each planned trajectory comprises data representing a respective observation at each of a sequence of planning time steps that starts at the current time step and includes a plurality of future time steps that are each after the current time step, the generating comprising, for each planned trajectory and at each planning time step other than a last planning time step in the sequence:
identifying an action to be performed by the agent in response to the observation at the planning time step in the planned trajectory; and
generating data specifying the observation at the subsequent planning time step in the planned trajectory, comprising processing a first input sequence for the planning time step that comprises a sequence of tokens from a vocabulary of tokens and representing the respective observation in the planned trajectory at the planning time step and one or more tokens from the vocabulary of tokens and representing the identified action at the planning time step, using a sequence-processing neural network, to generate an output sequence that comprises a sequence of tokens from the vocabulary of tokens that represents the observation at the subsequent planning time step in the planned trajectory;
selecting a planned trajectory from the plurality of planned trajectories; and
causing the agent to perform the identified action for the first planning time step in the selected planned trajectory.
